(19) United States
(12) Patent Application Publication
(10) Pub. No.: US 2023/0072264 A1
(43) Pub. Date: Mar. 9, 2023

(54) Method For Certification, Validation And Correlation Of Bills Of Materials In A Software Supply Chain

(71) Applicant: Julian COCCIA, Malaga (ES)

(72) Inventor: Julian COCCIA, Malaga (ES)

(21) Appl. No.: 17/404,675

(22) Filed: Aug. 17, 2021

(51) Int. Cl. G06F 21/44; G06F 16/27; H04L 9/32

(52) U.S. Cl. CPC G06F 21/44; G06F 16/27; H04L 9/3239; H04L 2209/38

(57) ABSTRACT

A method of validating a purported software bill of materials for a software package includes using a transaction ID to recover a reference file containing validating information about the bill of materials from a blockchain; comparing information about the purported bill of materials with information from the reference file about the bill of materials, and extracting information from the reference file to link the purported software bill of material with other preceding software bills of materials.

### FIELD

The present disclosure relates to software bills of materials, and in particular to methods of validating a bill of materials for a software package.

### BACKGROUND

This section provides background information related to the present disclosure which is not necessarily prior art.

The increasing popularity of free and open source code, and the increasing concern about license compliance, security vulnerabilities and code quality, has led to the need for a software bill of materials (SBOM) to facilitate data exchange in the software supply chain. Because of the vast number of individually generated SBOMs, and the ease of counterfeiting and tampering with such files, the validation of SBOMs and of the relationships between an SBOM and its corresponding code presents many challenges. Moreover, the information contained within a software bill of materials can be sensitive information. A public validation mechanism for a software bill of materials, its author, and the relationship of the bill of materials with predecessor bills of materials (whether for prior versions or for incorporated components) and a particular copy of the code, and which can protect potentially sensitive information was not previously available. Even with the increasing standardization of software bills of material formats in place, there is a need to formalize validation and interconnection of such software bills of materials in order to keep track of logical trees of distribution in the software supply chain.

These problems manifest when a programmer attempts to incorporate existing software into a new software package. Before incorporating the existing software, the programmer may want to ensure that the bill of material he or she has for the existing software package is legitimate; or to verify the identity of the publisher of the bill of material; or make sure that the code and its components correspond to the bill of materials. The programmer may also want to verify the components of the existing software, including verifying that the bill of materials for these components is legitimate; or verifying the identity of the publisher of the bill of materials for the components; or even verifying that the code corresponds to the BOM. Prior to the system and methods described herein, these were not simple or easy to accomplish.

### SUMMARY

The following simplified summary is provided for a basic understanding of some aspects of the various embodiments described in the present disclosure. The summary is not an extensive overview of the present disclosure. It is neither intended to identify all key or critical elements of the claimed invention(s) nor to delineate the scope of the invention. The following summary merely presents some concepts used in embodiments described in the present disclosure in a simplified form as a prelude to a more detailed description.

Some embodiments described in the present disclosure provide a system and a method for validating authenticity of a software bill of materials as well as the authenticity of the relation of such software bill of materials with its predecessors (either prior versions or incorporated component). In some of these embodiments this is achieved by creating an entry in a blockchain which contains a set of metadata from the current bill of materials and preferably its predecessors. These predecessors can include bills of materials for prior versions of the code, as wells of bills of materials for components incorporated into the code.

Some embodiments described in the present disclosure provide a data system for registering in a decentralized network, for example a blockchain, a record that is given a unique transaction ID (TXID) and that includes integrity information for a software bill of materials, it's author, and unique identifiers of predecessor software bills of materials that were previously registered in the blockchain, and integrity validation information for evidence used as input to produce such bill of materials while allowing the maintenance of the anonymity of the author as well as of the actual contents of the software bills of materials.

Some of the embodiments described herein may be based on the calculation of cryptographic hashes of the bill of materials, which may be used to validate integrity of a software bill of materials, and the inclusion in such bill of materials of the unique identifiers in the blockchain for any predecessor bills of materials that might be included in the bill of materials currently being registered. A benefit of these embodiments may be that they can allow validation of bills of materials by comparing its resulting cryprographic hashes, without having to have access to the original bill of materials document.

These and other features and advantages of the various embodiments of the invention will be more readily understood upon consideration of the following detailed description of the invention taken in conjunction with the accompanying drawings.

Further areas of applicability will become apparent from the description provided herein. The description and specific examples in this summary are intended for purposes of illustration only and are not intended to limit the scope of the present disclosure.

### DRAWINGS

Exemplifying and non-limiting embodiments of the present disclosure and their advantages are explained in greater detail below with reference to the accompanying drawings, in which:

FIG. 1 is a schematic diagram of a software supply chain tree, where software bills of materials are included in another other software bill of materials, and their metadata is cross-referenced;

FIG. 2 is a schematic diagram of the “composition of the BOM metadata and its registration in the blockchain in accordance with a preferred embodiment of this invention; and

FIG. 3 is an example of a JSON file to be recorded in a blockchain, after which will it be given a transaction ID (TXID) used in the methods of some of the embodiments of this invention.

Corresponding reference numerals indicate corresponding parts throughout the several views of the drawings.

### DETAILED DESCRIPTION

Some of the embodiments described herein allow for the registration of software bill of materials integrity metadata in a decentralized network, such as a blockchain. These embodiments can also allow software bills of materials integrity validation, authorship validation and relationship validation between software bill of materials in a publicly accessible network, revealing only cryptographic hashes and blockchain transaction IDs, preferably without storing and/or disclosing sensitive metadata from the software bill of materials contents.

In addition, some of the embodiments described herein allow for a decentralized storage, which is not dependent on the governance of any particular organization or individual, given the decentralized nature of the blockchain. This ensures the long-term preservation of software bill of materials metadata. Moreover, software bills of materials metadata stored in the blockchain are immutable, reducing or eliminating the possibility of data corruption.

Some of the embodiments described herein provide a quick and effective archival of software bill of materials metadata, by generating a JSON asset, which is a JSON-formatted file which contains a series of cryptographic hashes and optionally transaction IDs (TXIDs) and other metadata such as cryptographic hashes from predecessor software bills of materials (from prior versions of the software or from components that comprise part of the current software package for which the software bill of materials is being registered).

The JSON asset can also contain a list of cryptographic hashes of “input” media that was used to generate the bill of materials. This input media may include and is not limited to: source code that was analyzed to generate the bill of materials, configuration files used for such analysis, and/or bills of materials for predecessor software. The JSON asset preferably also contains the “output” cryptographic hash of the actual bill of materials for which it is being registered. Furthermore, the JSON asset preferably contains blockchain transaction IDs (TXIDs), or cryptographic hashes of other bills of materials related to the one being filed (e.g. bills of materials for components of the current software package, and/or bills of materials for prior versions of the current software package). The inclusion of other JSON assets TXIDs results in the ability to a link software bill of materials with its predecessors, resolving a significant challenge of tracing back a software bill of materials' sources.

### Validation of the Bills of Materials of Software Components

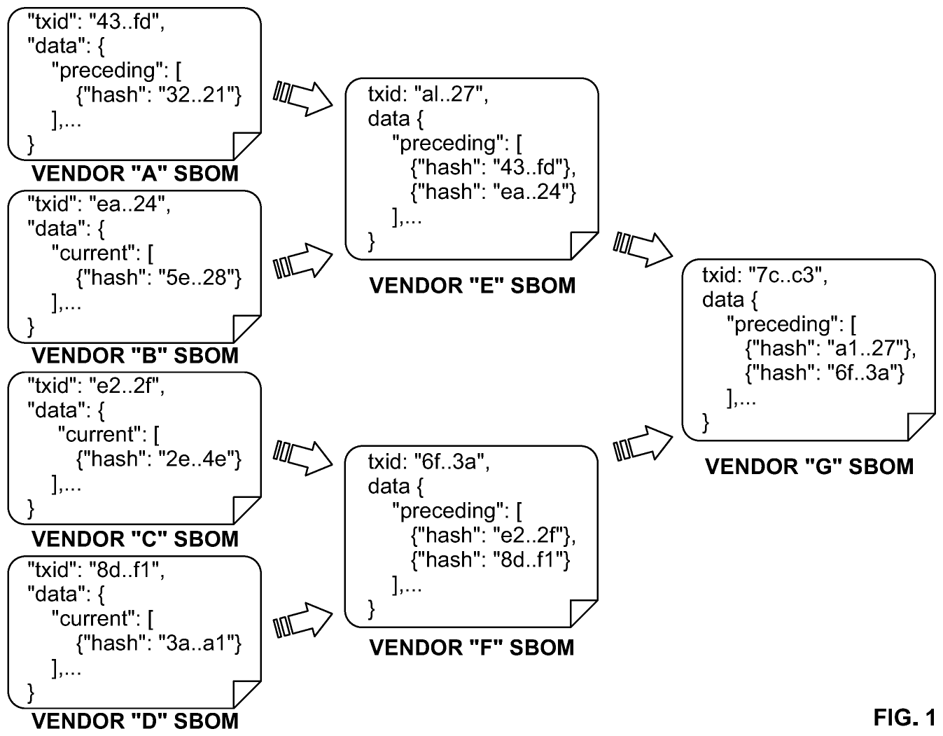

FIG. 1 shows a tree representation of different software bills of materials produced by different vendors, how those software bills of materials might be included in other bills of materials, and how the blockchain TXID can be used to track them back across the logical tree. Specifically, Vendor A's software and Vendor B's software might be incorporated in Vendor E's software, and Vendor E's bill of materials might include the blockchain TXID for Vendor A's bill of materials for the incorporated software, and the blockchain TXID for Vendor B's bill of materials for the incorporated software, and/or Vendor E might provide metadata files in accordance with the principles of this invention that include these blockchain TXIDs. Similarly, Vendor C's software and Vendor D's software might be incorporated in Vendor F's software, and Vendor F's bill of materials might include blockchain TXID for Vendor C's bill of materials for the incorporated software, and the blockchain TXID for Vendor D's bill of materials for the incorporated software, and/or Vendor F might provide metadata files in accordance with the principles of this invention that include these blockchain TXIDs. Finally, Vendor E's software and Vendor F's software might be incorporated in Vendor G's software, and Vendor G's bill of materials might include the blockchain TXID for Vendor E's bill of materials for the incorporated software, and the blockchain TXID for Vendor F's bill of materials for the incorporated software, and/or Vendor G might provide metadata files in accordance with the principles of this invention that include these blockchain TXIDs. The TXID for the software bill of materials from Vendor G would allow the possessor of Vendor G's software and putative corresponding bill of materials to recover information to verify the accuracy and completeness of the putative bill of materials and to further verify that the bill of materials corresponds to the software packages from Vendors A, B, C, D, E, and F.

More specifically, the TXID of the metadata file from Vendor G allows the recipient to access the TXID's of Vendor's E and F metadata files. In turn the metadata files of Vendor E allows the recipient to access the TXID's of Vendors A and B, and ultimately their metadata files. Similarly, the metadata files of Vendor F allows the recipient to access the TXID's of Vendors C and D, and ultimately their metadata files. Thus Vendor G safely and securely allows its customers access to validating information for the third party components of its software. These customers can validate the source of bill of materials information they have, validate the bills of materials themselves, and through hashes of the code and the configuration files, validate that the software corresponds to the bills of materials.

### Validation of the Author/Source of a Bill of Material

Validation of the author of a given software bill of materials can be performed by some of the embodiments described herein, since each blockchain transaction is associated with an author identifier. The TXID for the metadata file can be used to recover the metadata file from the blockchain, and the author identified associated with the particular transaction can be compared with the identified provided with the putative bill of materials. This comparison validates that the source of the putative software bill of materials is the same as the source of the metadata file.

### Validation of a Putative Bill of Materials

The validation of a putative software bill of materials file, as well as the integrity of the software and/or configuration files included in such software bill of materials, can be performed by simply calculating the cryptographic hash of the putative bill of materials and comparing it with the one registered in the corresponding JSON asset in the blockchain. If they match the recipient is assured that the putative bill of material is in fact correct. The hash comparison is swifter and easier than comparing the entire bill of materials, and it does not require that the software vendor make the bill of materials publicly available.

In addition, the recipient may wish to confirm that the software received actually corresponds to the validated bill of materials. This can be can be performed by simply calculating the cryptographic hash of the software files and/or the configuration files, and comparing them to the hashes of the software files and/or configuration files in corresponding JSON asset in the blockchain. If these hatches match, then the recipient is assured that the files correspond to the previously validated bill of materials.

### Creation of the JSON Asset (Metadata) File

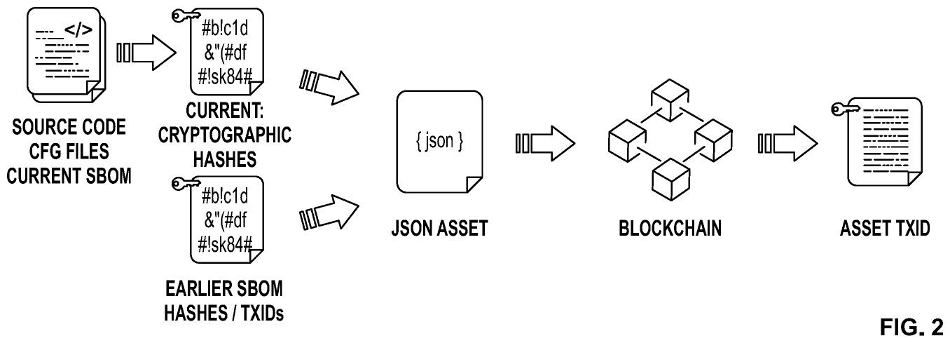

FIG. 2 is a schematic diagram illustrating how cryptographic hashes of source code files, configuration files and predecessor software bills of materials can be assembled into a JSON asset file, together with the cryptographic hash of the software bill of materials being generated, and the blockchain unique transaction identifiers (TXIDs) of other “predecessor” software bills of materials related to the one being filed, and/or of bill of materials of prior versions of the software whose bill of materials is being registered. All of this metadata represented in the JSON asset file is published in the blockchain where it is given a unique blockchain transaction identifier (TXID).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### Example

The following example illustrates the creation and use of JSON asset files and their corresponding unique blockchain transaction identifier (TXID):

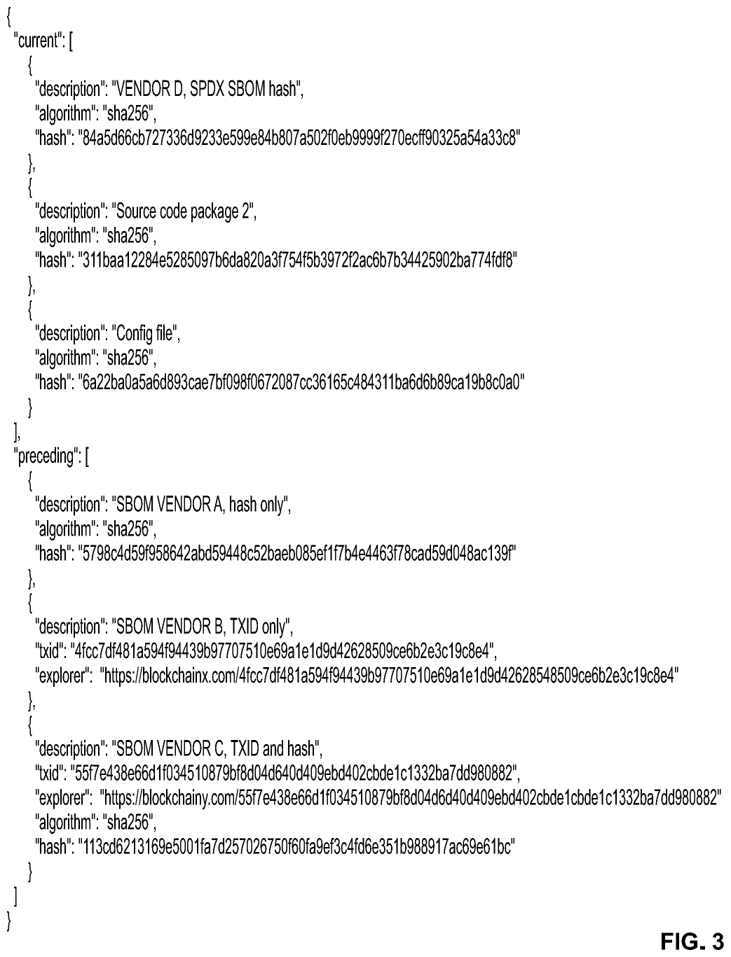

Vendors A, B and C provide software packages A, B, and C, to vendor D. Along with the software package, Vendor A delivers a software bill of materials BOM_{A}. Vendors B and C deliver also their software bill of materials BOM_{B} and BOM_{C} along with the TXIDs in the blockchain where the validation metadata is published TXID_{B} and TXID_{C}. Vendor D develops a software package D which includes the software A, B, and C delivered by vendors A, B and C. In accordance with the principles of a preferred embodiment of this invention, a reference file is created (FIG. 3) with one or more of the following components:

(a) a cryptographic hash of the current bill of materials BOM_{D} for the software package D, along with a description and the name of the algorithm of choice, e.g.:

```
  {
      “description”: “VENDOR D, SPDX SBOM hash”,
      “algorithm”: “sha256”,
      “hash”:
“84a5d66cb727336d9233e599e84b807a502f0eb9999f270ecff90325a54a33c8”
    }
```

(b) a set of blockchain transaction identifiers (TXIDs) of reference files for an earlier version of the software bill of materials and/or for preexisting components, which can include a description, cryptographic algorithms and a blockchain explorer URL for direct access the public record for the provided TXID, e.g:

```
    {
      “description”: “SBOM VENDOR B, TXID only”,
      “txid”:
“4fcc7df481a594f94439b97707510e69a1e1d9d42628548509ce6b2e3c19c8e4”,
      “explorer”:
  https://blockchainx.com/4fcc7df481a594f94439b97707510e69a1e1d9d42628548
  509ce6b2e3c19c8e4
      “description”: “SBOM VENDOR C, TXID and hash”,
      “txid”:
“55f7e438e66d1f034510879bf8d04d640d409ebd402cbde1c1332ba7dd980882”,
      “explorer”:
“https://blockchainy.com/55f7e438e66d1f034510879bf8d04d640d409ebd402cbde1c133
2ba7dd980882”,
      “algorithm”: “sha256”,
      “hash”:
“113cd6213169e5001fa7d257026750f60fa9ef3c4fd6e351b988917ac69e61bc”
    }
  (c) a set of cryptographic hashes of the software included in the software bill of
materials, e.g:
    {
      “description”: “Source code package 1”,
      “algorithm”: “sha256”,
      “hash”:
“311baa12284e5285097b6da820a3f754f5b3972f2ac6b7b34425902ba774fdf8”
    },
    {
      “description”: “Source code package 2”,
      “algorithm”: “sha256”,
      “hash”:
“05c4a1a9730a97e8554936af82145b9e1631f78a7d0a50d9bd27acae19dc7cf9”
    }
  (d) a cryptographic hash of the configuration files used in conjunction with the
software to generate the software bill of materials , e.g:
    {
      “description”: “Config file”,
      “algorithm”: “sha256”,
      “hash”:
“6a22ba0a5e6d893cae7bf098f0672087cc36165c484311ba6d6b89ca19b8c0a0”
    }
```

Once this file is published in the blockchain, it will typically be associated with a) a TXID, b) a timestamp, c) the user ID who created the blockchain entry.

The hashes can be produced by any cryptographic hash algorithms, including SHA-1, SHA-2, SHA-3, RIPEMD-160, Whirlpool, BLAKE2, BLAKE3, or other suitable algorithm, which preferably produces an alpha numeric sequence of fixed length that is deterministic, quick to compute, irreversible, unique, and which changes substantially with small changes to the input file.

The selected components are assembled into a metadata reference file, preferably in JavaScript Object Notation (JSON) form, JSON_{NEW}. The JSON_{NEW} reference file is then broadcast to a block chain, for example blockchainX and blockchainY, and a transaction ID, TXID_{NEW} is generated for the JSON_{NEW} reference file. Recipients of the TXID_{NEW} transaction ID can use it to recover the JSON_{NEW} reference file. With the JSON_{NEW} reference file, the validity of a putative BOM_{NEW} can be tested. For example, if the JSON_{NEW} contains a hash of the BOM_{NEW}, this has can be compared with a hash of the putative BOM_{NEW}. If the hashes are the same, the BOMs are the same. Alternatively, or in addition, any of the other constituents of the JSON_{NEW} file can be compared with a corresponding constituent of the putative BOM_{NEW}, to validate the putative BOM_{NEW}.

The JSON_{NEW} file can also contain files to validate that the putative Package_{NEW} corresponds to the putative BOM_{NEW}. For example if the JSON_{NEW} contains a hash of one or more of the software or configuration files of the Package_{NEW} this hash can be compared to a hash of the corresponding file in the putative Package_{NEW} to confirm that the putative Package_{NEW} corresponds to the confirmed BOM_{NEW}.

Recipients of the TXID_{NEW} transaction ID can use it to recover the associated blockchain user ID and publication timestamp, which can be used cross-reference and validate authenticity of the JSON_{NEW} file, by comparing the ID associated with the TXID_{NEW} with the ID provided with the putative software bill of materials

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method of providing a reference for validating a purported software bill of materials for a software package, the method comprising:
creating a reference file containing (i) information about the bill of materials for the software package; and (ii) information about the software in the software package;
broadcasting the reference file in a blockchain and obtaining the corresponding unique transaction identifier (TXID);
publishing the TXID so that someone wanting to validate the software bill of materials for a particular software package can access the reference file.

2. The method according to claim 1 wherein the reference file is a JSON file.

3. The method according to claim 2 wherein the information about the bill of materials for the software package comprises at least one of: creating a reference file containing at least one of: (a) a cryptographic hash of the bill of materials of at least one prior version of the software package; (b) a cryptographic hash of the bill of materials for the software package; and (c) a blockchain transaction identifiers (TXIDs) of a precursor software bill of materials.

4. The method of claim 3 wherein the information about the bill of materials for the software package comprises a cryptographic hash of the bill of materials for the software package.

5. The method according to claim 3 wherein the information about the software in the software package comprises at least one of: (a) a cryptographic hash of the software included in the software bill of materials; (b) a cryptographic hash of the configuration files used in conjunction with the software included in the software bill of materials; and (c) a cryptographic hash of the software included in the software bill of materials.

6. A method of providing a reference for validating a software bill of materials for a software package, the method comprising:
creating a reference file containing at least one of: (a) a cryptographic hash of the software included in the software bill of materials; (b) a cryptographic hash of the configuration files used in conjunction with the software included in the software bill of materials; (c) a cryptographic hash of at least one configuration file used in conjunction with the software that is the subject; (d) a cryptographic hash of the bill of materials of at least one prior version of the software package; (e) a cryptographic hash of the bill of materials for the software package; and (f) a blockchain transaction identifiers (TXIDs) of an earlier version of the software bill of materials and broadcasting the reference file in a blockchain and obtaining the corresponding unique transaction identifier (TXID);
publishing the TXID so that someone wanting to validate the software bill of materials for a particular software package can access the reference file.

7. The method according to claim 6 wherein the reference file is a JSON file.

8. A method of validating a purported software bill of materials for a software package, the method comprising:
using a transaction ID to recover a reference file containing validating information from the blockchain, the validating information about the bill of materials for the software package; and
comparing information about the purported bill of materials with information from the reference file about the bill of materials.

9. The method according to claim 8 wherein the reference file is a JSON file.

10. The method of claim 8 wherein the information about the bill of materials for the software package comprises a cryptographic hash of the bill of materials for the software package.

11. The method of validating a purported software bill of material for a software package according to claim 8, wherein the validating information includes information about the software in the software package, and further comprising comparing information from the purported bill of materials with information from the reference file about software that is the subject of the purported the bill of materials.

12. The method according to claim 11 wherein the reference file is a JSON file.

13. The method according to claim 8 wherein the information about the bill of materials for the software package comprises at least one of: creating a reference file containing at least one of: (a) a cryptographic hash of the bill of materials of at least one prior version of the software package; (b) a cryptographic hash of the bill of materials for the software package; (c) a blockchain transaction identifiers (TXIDs) of an earlier version of the software bill of materials; and (d) blockchain transaction identifiers (TXIDs) of a predecessor software bill of materials which contents make part of the the present software bill of materials.

14. The method according to claim 13 wherein the information about the software in the software package comprises at least one of: (a) a cryptographic hash of the software included in the software bill of materials; (b) a cryptographic hash of the configuration files used in conjunction with the software included in the software bill of materials; (c) a cryptographic hash of the software included in the software bill of materials; (d) a cryptographic hash of at least one configuration file used in conjunction with the software that is the subject.

15. The method according to claim 8 wherein the information about the software in the software package comprises at least one of: (a) a cryptographic hash of the software included in the software bill of materials; (b) a cryptographic hash of the configuration files used in conjunction with the software included in the software bill of materials; (c) a cryptographic hash of the software included in the software bill of materials; (d) a cryptographic hash of at least one configuration file used in conjunction with the software that is the subject.

16. The method according to claim 8, further comprising comparing a blockchain user id and publication timestamp from the blockchain with information provided with the purported software bill of materials for further validation of the software bill of materials.
